(19) United States
(12) Patent Application Publication
(10) Pub. No.: US 2017/0247951 A1
(43) Pub. Date: Aug. 31, 2017

(54) POLYCRYSTALLINE DIAMOND CUTTING ELEMENTS WITH MODIFIED CATALYST DEPLETED PORTIONS AND METHODS OF MAKING THE SAME

(71) Applicant: DIAMOND INNOVATIONS, INC., Worthington, OH (US)

(72) Inventor: Abhijit SURYAVANSHI, Issaquah, WA (US)

(21) Appl. No.: 15/437,893

(22) Filed: Feb. 21, 2017

Related U.S. Application Data
(60) Provisional application No. 62/299,592, filed on Feb. 25, 2016.

(51) Int. Cl. E21B 10/567; B24D 3/10; C04B 35/638; C04B 35/52; C04B 35/63; B24D 18/00; C22C 26/00

(52) U.S. Cl. CPC E21B 10/567; B24D 18/0009; B24D 3/10; C22C 26/00; C04B 35/52; C04B 35/6303; C04B 35/638; C04B 2235/427; C04B 2235/85

(57) ABSTRACT

Polycrystalline diamond cutting elements with modified catalyst depleted portions and methods of making the same are disclosed herein. A method may include removing inter-bonded diamond grains along an outer surface of a polycrystalline diamond compact to form a frustoconical surface, introducing the polycrystalline diamond compact to a leaching process in which catalyst material that is positioned within interstitial regions between the inter-bonded diamond grains is removed from the polycrystalline diamond compact, and removing inter-bonded diamond grains along the outer surface of the polycrystalline diamond compact to form a polycrystalline diamond cutting element having a peripheral surface.

### CROSS-REFERENCE TO RELATED APPLICATIONS

None.

### TECHNICAL FIELD AND INDUSTRIAL APPLICABILITY

The present invention relates generally to polycrystalline diamond cutting elements and methods of making polycrystalline diamond cutting elements, and more particularly, to polycrystalline diamond cutting elements with modified catalyst depleted portion.

### BACKGROUND

Polycrystalline diamond (“PCD”) compacts and cutting elements are used in a variety of mechanical applications, for example in material removal operations, as bearing surfaces, and in wire-draw operations. PCD compacts are often used in the petroleum industry in the removal of material in downhole drilling. The PCD compacts are formed as cutting elements, a number of which are attached to drill bits, for example, roller-cone drill bits and fixed-cutting element drill bits.

PCD cutting elements typically include a superabrasive diamond layer, referred to as a polycrystalline diamond body that is attached to a substrate. The polycrystalline diamond body may be formed in a high pressure high temperature (HPHT) process, in which diamond grains are held at pressures and temperatures at which the diamond particles bond to one another.

As is conventionally known, the diamond particles are introduced to the HPHT process in the presence of a catalyst material that, when subjected to the conditions of the HPHT process, promotes formation of inter-diamond bonds. The catalyst material may be introduced to the diamond particles in a variety of ways, for example, the catalyst material may be embedded in a substrate such as a cemented tungsten carbide substrate having cobalt. The catalyst material may infiltrate the diamond particles from the substrate. Following the HPHT process, the diamond particles may be sintered to one another and attached to the substrate.

While the catalyst material promotes formation of the inter-diamond bonds during the HPHT process, the presence of the catalyst material in the sintered diamond body after the completion of the HPHT process may also reduce the stability of the polycrystalline diamond body at elevated temperatures. Some of the diamond grains may undergo a back-conversion to a softer non-diamond form of carbon (for example, graphite or amorphous carbon) at elevated temperatures. Further, mismatch of the coefficients of thermal expansion between diamond and the catalyst may induce stress into the diamond lattice causing microcracks in the diamond body. Back-conversion of diamond and stress induced by the mismatch of coefficients of thermal expansion may contribute to a decrease in the toughness, abrasion resistance, and/or thermal stability of the PCD cutting elements during operation.

It is conventionally known to at least partially remove catalyst material from the PCD by introducing at least a portion of the PCD to a leaching agent. However, the rate of removal of the catalyst material from the PCD may slow as the distance from the exterior surfaces of the PCD increases, thereby increasing the time of production of the PCD cutting elements and, therefore, the costs associated with manufacturing.

Accordingly, PCD cutting elements having modified catalyst depleted portion and methods for making the may be desired.

### SUMMARY

In one embodiment, a polycrystalline diamond cutting element includes a substrate and a polycrystalline diamond body attached to the substrate along an interface. The polycrystalline diamond body includes a plurality of inter-bonded diamond grains separated from one another by interstitial regions. The polycrystalline diamond body includes a generally planar working surface and a peripheral surface that extends transverse to the working surface. The polycrystalline diamond body includes a catalyst rich portion in which the interstitial regions of the polycrystalline diamond body comprise catalyst material, and a catalyst depleted portion in which the interstitial regions of the polycrystalline diamond body are substantially free of catalyst material. An intersection of the catalyst rich portion and the catalyst depleted portion of the polycrystalline diamond body create a catalyst transition zone. The catalyst transition zone includes a generally planar portion that is surrounded by an arcuate portion. A center of a radius of curvature of the arcuate portion is spaced closer to the working surface than to the peripheral surface of the polycrystalline diamond body.

In another embodiment, a polycrystalline diamond compact includes a substrate and an axially symmetric polycrystalline diamond body attached to the substrate along an interface. The polycrystalline diamond body includes a generally planar working surface and a frustoconical side surface that extends away from the working surface and intersects with a generally cylindrical surface and that extends along at least 50% of a thickness of the polycrystalline diamond body such that the polycrystalline diamond body has a smaller diameter at the working surface than at the interface.

In yet another embodiment, a method of making a polycrystalline diamond cutting element includes removing inter-bonded diamond grains along an outer surface of a polycrystalline diamond compact to form a frustoconical surface that extends away from a generally planar working surface and intersects with a generally cylindrical surface such that the polycrystalline diamond body has a smaller diameter at the working surface than at the interface. The method also includes introducing the polycrystalline diamond compact to a leaching process in which catalyst material that is positioned within interstitial regions between the inter-bonded diamond grains is removed from the polycrystalline diamond compact, where the working surface and the frustoconical surface are maintained in intimate contact with a leaching agent. The method further includes removing inter-bonded diamond grains along the outer surface of the polycrystalline diamond compact to form a polycrystalline diamond cutting element having a peripheral surface.

### BRIEF DESCRIPTION OF THE DRAWINGS

The foregoing summary, as well as the following detailed description of the embodiments, will be better understood when read in conjunction with the appended drawings. It should be understood that the embodiments depicted are not limited to the precise arrangements and instrumentalities shown.

FIG. 1 is a schematic perspective view of a polycrystalline diamond cutting element according to one or more embodiments shown or described herein;

FIG. 2 is a cross-sectional view of the polycrystalline diamond compact of FIG. 1;

FIG. 3 is an enlarged cross-sectional view of the polycrystalline diamond compact FIG. 1;

FIG. 4 is a flow chart illustrating a method of making a polycrystalline diamond compact according to one or more embodiments shown or described herein; and

FIG. 5 is a schematic perspective view of a polycrystalline diamond compact according to one or more embodiment shown or described herein.

### DETAILED DESCRIPTION

The present disclosure is directed to polycrystalline diamond cutting elements having modified catalyst depleted portions and methods of making the same. It is conventionally known to form polycrystalline diamond cutting elements in a high pressure high temperature (HPHT) process in which unbonded diamond grains are subjected to elevated temperature and pressure in the presence of a solvent catalyst. The solvent catalyst enhances diamond-to-diamond bonding between the grains, thereby forming an integral polycrystalline diamond body in the HPHT process.

The solvent catalyst may remain in the interstitial regions between adjacent diamond grains. The presence of the solvent catalyst in the polycrystalline diamond body may be detrimental to performance of the polycrystalline diamond cutting element in end-user applications. Accordingly, at least portions of the solvent catalyst may be removed from the accessible interstitial regions of the polycrystalline diamond body. The removal of the solvent catalyst forms a catalyst rich portion of the polycrystalline diamond body in which the solvent catalyst remains in the interstitial regions and a catalyst depleted portion of the polycrystalline diamond body in which the interstitial regions of the polycrystalline diamond body are substantially free of solvent catalyst.

It has been determined that increasing the size of the catalyst depleted region of the polycrystalline diamond body may improve performance of the polycrystalline diamond cutter element for particular end-user applications. However, removal of the solvent catalyst from the polycrystalline diamond body is a time consuming process, and therefore is expensive. Further, removal of the solvent catalyst from the polycrystalline diamond body slows as the depth from the external surfaces of the polycrystalline diamond body increases. Accordingly, methods of enhancing removal of deeply positioned solvent catalyst may be desired.

Embodiments according to the present disclosure are directed to polycrystalline diamond cutting elements having modified catalyst depleted portions and methods of making the same. Embodiments of the polycrystalline diamond cutting elements may include a polycrystalline diamond body that is attached to a substrate along an interface. The polycrystalline diamond body may include a plurality of inter-bonded diamond grains that are separated from one another by interstitial regions. The polycrystalline diamond body may include a catalyst rich portion in which the interstitial regions comprise catalyst material and a catalyst depleted portion in which the interstitial regions of the polycrystalline diamond body are substantially free of catalyst material. The catalyst rich portion and the catalyst depleted portion may meet at an intersection. The intersection may have a generally planar portion that is surrounded by an arcuate portion. The center of the radius of curvature of the arcuate portion may be spaced closer to the working top surface than to the peripheral surface of the polycrystalline diamond body.

The polycrystalline diamond cutting element may be fabricated by introducing a frustoconical surface to an outer surface of a pre-finished polycrystalline diamond compact. The frustoconical surface may be tapered as to form a smaller diameter at the working surface of the polycrystalline diamond body than at the interface between the polycrystalline diamond body and the substrate. The polycrystalline diamond body may be brought into intimate contact with a leaching agent that removes the solvent catalyst from the accessible interstitial regions of the polycrystalline diamond body. The shape of the frustoconical surface along the polycrystalline diamond body may allow for deeper penetration of the leaching agent to increase the depth and rate of removal of the solvent catalyst from the proximate interstitial regions of the polycrystalline diamond body. Following termination of the solvent catalyst removal process, the polycrystalline diamond body maybe further processed, such that the frustoconical surface of the polycrystalline diamond body is removed. Subsequent to such processing, the polycrystalline diamond body may continue to exhibit solvent catalyst removal at deeper positions evaluated from the exterior surfaces of the polycrystalline diamond body as compared to conventionally-produced polycrystalline diamond cutting elements. These and other elements will be discussed in greater detail below with respect to the appended drawings.

Before the description of the embodiment, terminology, methodology, systems, and materials are described; it is to be understood that this disclosure is not limited to the particular terminologies, methodologies, systems, and materials described, as these may vary. It is also to be understood that the terminology used in the description is for the purpose of describing the particular versions of embodiments only, and is not intended to limit the scope of embodiments. For example, as used herein, the singular forms “a,” “an,” and “the” include plural references unless the context clearly dictates otherwise. In addition, the word “comprising” as used herein is intended to mean “including but not limited to.” Unless defined otherwise, all technical and scientific terms used herein have the same meanings as commonly understood by one of ordinary skill in the art.

Unless otherwise indicated, all numbers expressing quantities of ingredients, properties such as size, weight, reaction conditions and so forth used in the specification and claims are to the understood as being modified in all instances by the term “about”. Accordingly, unless indicated to the contrary, the numerical parameters set forth in the following specification and attached claims are approximations that may vary depending upon the desired properties sought to be obtained by the invention. At the very least, and not as an attempt to limit the application of the doctrine of equivalents to the scope of the claims, each numerical parameter should at least be construed in light of the number of reported significant digits and by applying ordinary rounding techniques.

As used herein, the term “about” means plus or minus 10% of the numerical value of the number with which “about” is associated. Therefore, “about 40%” means in the range of 36%-44%.

As used herein, the term “superabrasive particles” may refer to ultra-hard particles or superabrasive particles having a Knoop hardness of 3500 KHN or greater. The superabrasive particles may include diamond and cubic boron nitride, for example. The term “abrasive”, as used herein, refers to any material used to wear away softer materials.

The term “particle” or “particles”, as used herein, refers to a discrete body or bodies. A particle is also considered a crystal or a grain.

The term “cutting element”, as used herein, means and includes any element of an earth-boring tool that is used to cut or otherwise disintegrate formation material when the earth-boring tool is used to form or enlarge a bore in the formation.

The term “earth-boring tool”, as used herein, means and includes any tool used to remove formation material and form a bore (e.g., a wellbore) through the formation by way of removing the formation material. Earth-boring tools include, for example, rotary drill bits (e.g., fixed-compact or “drag” bits and roller cone or “rock” bits), hybrid bits including both fixed compacts and roller elements, coring bits, percussion bits, bi-center bits, reamers (including expandable reamers and fixed-wing reamers), and other so-called “hole-opening” tools.

The term “feed” or “diamond feed”, as used herein, refers to any type of diamond particles, or diamond powder, used as a starting material in further synthesis of PDC compacts.

The term “polycrystalline diamond”, as used herein, refers to a plurality of randomly oriented or highly oriented monocrystalline diamond particles, which may represent a body or a particle consisting of a large number of smaller monocrystalline diamond particles of any sizes. In general, polycrystalline diamond particles do not exhibit cleavage planes.

The terms “diamond particle” or “particles” or “diamond powder” or “diamond grains”, which is a plurality of single crystals or polycrystalline diamond particles, are used synonymously in the instant application and have the same meaning as “particle” defined above.

Polycrystalline diamond compacts (or “PCD compacts”, as used hereinafter) may refer to a volume of crystalline diamond grains with embedded foreign material filling the inter-granular space. In one embodiment, a PCD compact includes crystalline diamond grains that are bound to each other by strong diamond-to-diamond bonds and form a rigid polycrystalline diamond body. Interstitial regions are disposed between the bonded diamond grains and filled at least in one part with a metal solvent catalyst material that was used to promote diamond bonding during fabrication. The interstitial regions may also be at least partially filled with other non-catalyst materials that may remain after the sintering of diamond compact. Suitable metal solvent catalysts may include the iron group transitional metals in Group VIII of the Periodic table, including, for example, cobalt, iron, nickel, or combinations thereof.

“Thermally stable polycrystalline diamond,” as used herein, is understood to refer to intercrystalline bonded diamond that includes a volume or region that is or that has been rendered substantially free of the solvent metal catalyst or binder used to form PCD, or the solvent metal catalyst or binder used to form PCD remains in the region of the diamond body but is otherwise reacted or otherwise rendered ineffective in its ability adversely impact the bonded diamond at elevated temperatures as discussed above.

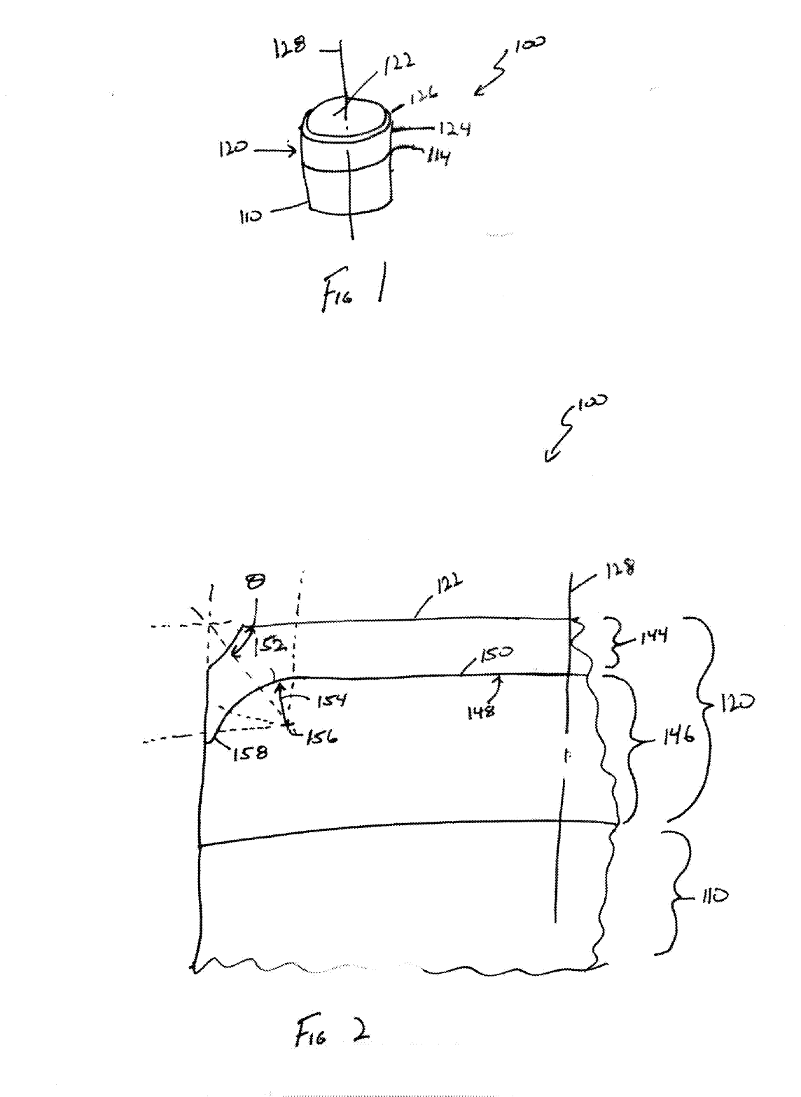

Referring now to FIG. 1, a polycrystalline diamond cutting element 100 according to one embodiment is depicted. The polycrystalline diamond cutting element 100 includes a substrate 110 and a polycrystalline diamond body 120 that is attached to the substrate 110 along an interface 114. The polycrystalline diamond body 120 includes a working surface 122 and a peripheral surface 124 that circumscribes the working surface 122. As depicted in the embodiment of FIG. 1, the peripheral surface 124 is generally cylindrical and the working surface 122 is generally circular and are generally circularly symmetric about a centerline axis 128; however, other shapes of the polycrystalline diamond body 120 and the substrate 110 are envisioned without departing from the scope of the disclosure. In some embodiments, the polycrystalline diamond body 120 includes a chamfer 126 that extends between the working surface 122 and the peripheral surface 124.

Referring now to FIG. 3, the polycrystalline diamond body 120 includes a plurality of inter-bonded diamond gains 140 that are separated from one another by interstitial regions 142. The interstitial regions 142 may be present during the formation of the polycrystalline diamond body 120, and may result from the packing of the diamond grains prior to sintering in an HPHT process. The polycrystalline diamond body 120 may be subjected to a catalyst material removal process, for example, a chemical leaching process, which will be described below in greater detail. The catalyst material removal process may substantially deplete all of the catalyst material from a portion of the accessible interstitial regions 142a in a catalyst depleted portion 110 that is positioned proximate to the exterior surfaces of the polycrystalline diamond body 120, while preserving the catalyst material in the interstitial regions 142b of a catalyst rich portion 146 that are positioned distally from the exterior surfaces of the polycrystalline diamond body 120. The catalyst depleted portion 110 and the catalyst rich portion 146 of the polycrystalline diamond body 120 may form an intersection 148 that defines the approximate separation between the catalyst depleted portion 144 and the catalyst rich portion 146.

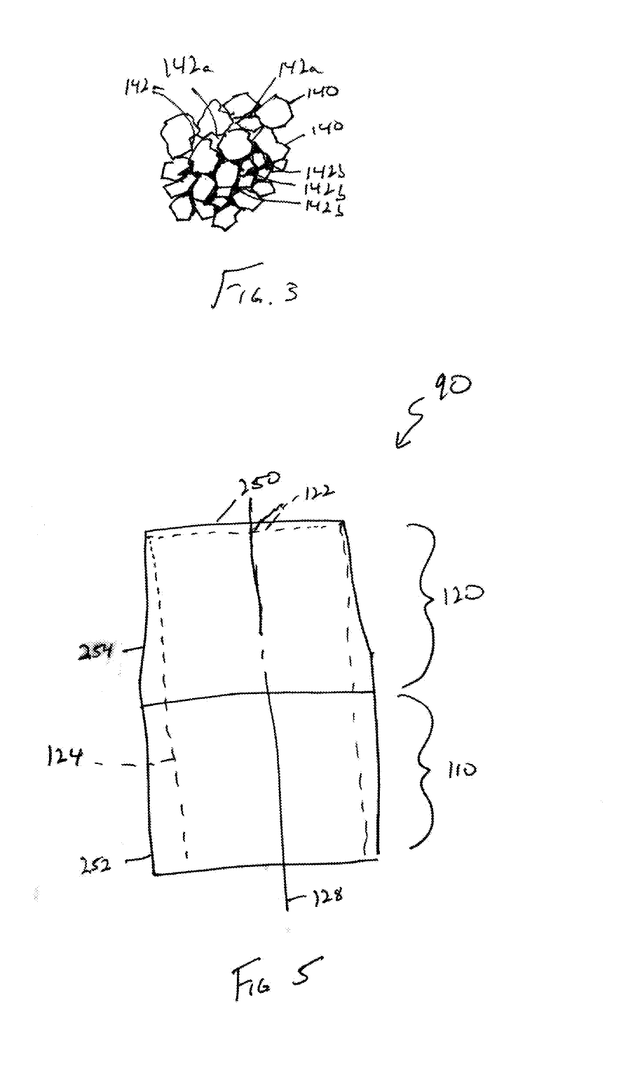

As depicted in FIG. 2, the catalyst depleted portion 144 is positioned proximate to the working surface 122 and the peripheral surface 124 of the polycrystalline diamond body 120. The catalyst rich portion 146 is spaced apart from the working surface 122 of the polycrystalline diamond body 120. As depicted in FIG. 3, the catalyst rich portion 146 may extend to the peripheral surface of the polycrystalline diamond body 120. The distances that the intersection 148 is positioned from the working surface 122 may be greater when evaluated along the peripheral surface 124 than the distance evaluated along the centerline axis 128 of the polycrystalline diamond body 120.

As depicted in FIG. 2, the intersection 148 may include a generally planar portion 150 that is positioned along the centerline axis 128 of the polycrystalline diamond portion 120 and away from the peripheral surface 124. The generally planar portion 150 of the intersection 148 extends to an arcuate portion 152 that surrounds the generally planar portion 150. The arcuate portion 152 may have a radius of curvature 154 about which the arcuate portion 152 is centered. The center 156 of the radius of curvature 154 may be positioned closer to the working surface 122 of the polycrystalline diamond body 120 than to the peripheral surface 124 of the polycrystalline diamond body 120. In one embodiment, a line that extends from a geometric intersection of the working surface 122 and the peripheral surface 124 of the polycrystalline diamond body 120 and the center 156 of the radius of curvature 154 may be at an angle that is less than about 40 degrees from the working surface 120 of the polycrystalline diamond body 120. In one embodiment, a tangency point of the intersection 148 at the planar portion 150 to the arcuate portion 152 is spaced apart from the peripheral surface 124 a distance that is greater than the radius of curvature of the arcuate portion 152. In some embodiments, the intersection 148 may further include a frustoconical portion 158 that extends outward from the arcuate portion 152.

As compared to conventional leached polycrystalline diamond cutters, the polycrystalline diamond cutting elements 100 according to the present disclosure may have more catalytic material removed from areas proximate to the peripheral surface 124. By increasing the amount of catalytic material removed from this location, the region of the polycrystalline diamond cutter element 100 that is brought in to contact with the material to be removed may exhibit enhanced thermal stability, which may improve the abrasion resistance of the polycrystalline diamond cutting element 100 for particular end-user applications, including for use in an earth-boring tool.

In one manufacturing process, cutting elements may be produced in a “single press” HPHT process in which diamond particles are bonded to one another and a substrate to form a cutting element having an integral diamond body with diamond grains bonded to one another in diamond-to-diamond bonds and interstitial regions between the diamond grains. Some of the interstitial regions include catalyst material, metal carbide, or combinations thereof. Portions of the diamond body are maintained in contact with a leaching agent that removes substantially all of the catalyst material and catalyst material from a catalyst depleted portion positioned at the working surface of the cutting element and extending toward the substrate to a transition zone in which the leached region abuts the catalyst rich portion having a high centration of catalyst material within the interstitial regions.

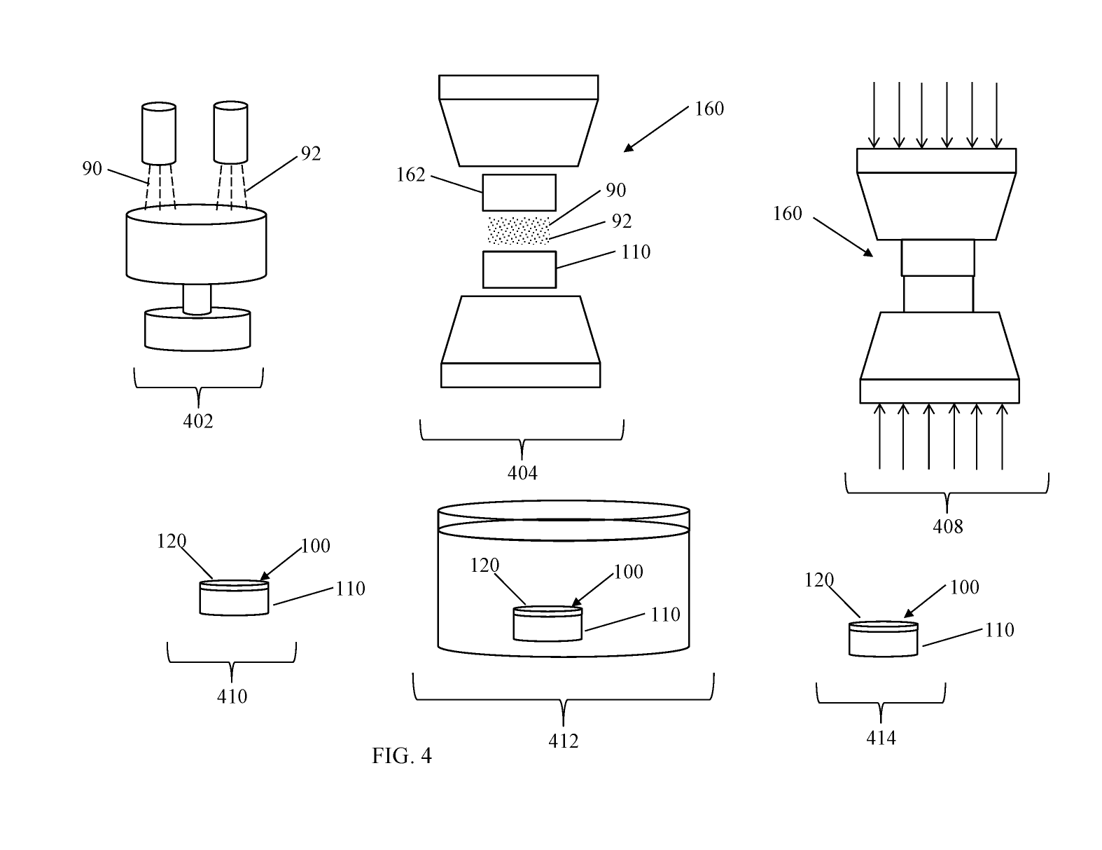

Referring now to FIG. 4, a flowchart depicting a manufacturing procedure 400 is provided. Diamond particles 90 may be optionally mixed with a catalyst material 92 in step 402. The size of the diamond particles 90 may be selected based on the desired mechanical properties of the polycrystalline diamond cutting element that is finally produced. It is generally believed that a decrease in grain size increases the abrasion resistance of the polycrystalline diamond cutting element, but decreases the toughness of the polycrystalline diamond cutting element. Further, it is generally believed that a decrease in grain size results in an increase in interstitial volume of the PCD compact. In one embodiment, the diamond particles 90 may have a single mode median volumetric particle size distribution (D50) in a range from about 10 μm to about 100 μm, for example having a D50 in a range from about 14 μm to about 50 μm, for example having a D50 of about 30 μm to about 32 μm. In other embodiments, the diamond particles 90 may have a D50 of about 14 μm, or about 17 μm, or about 30 μm, or about 32 μm. In other embodiments, the diamond particles 90 may have a multimodal particle size, wherein the diamond particles 90 are selected from two or more single mode populations having different values of D50, including multimodal distributions having two, three, or four different values of D50.

In other embodiments, the catalyst material 92 may be positioned separately from the diamond particles 90. During the first HPHT process, the catalyst materials 92 may “sweep” from their original location and through the diamond particles 90, thereby positioning the catalyst materials 92 prior to sintering of the diamond particles 90. The HPHT process promoting formation of inter-diamond bonds between the diamond particles 90 and sintering of the diamond particles 90 to form the polycrystalline diamond body 120 of the polycrystalline diamond compact 90.

The diamond particles 90 and the catalyst material 92 may be positioned within a cup 162 that is made of a refractory material, for example tantalum, niobium, vanadium, molybdenum, tungsten, or zirconium, as shown in step 404. The substrate 110 is positioned along an open end of the cup 162 and is optionally welded to the cup 162 to form cell assembly 160 that encloses diamond particles 90 and the catalyst material 92. The substrate 110 may be selected from a variety of hard phase materials including, for example, cemented tungsten carbide, cemented tantalum carbide, or cemented titanium carbide. The substrate 110 may include a pre-determined quantity of catalyst material 92. Using a cemented tungsten carbide-cobalt system as an example, the cobalt is the catalyst material 92 that is infiltrated into the diamond particles 90 during the HPHT process. In other embodiments, the cell assembly 160 may include additional catalyst material (not shown) that is positioned between the substrate 110 and the diamond particles 90. In further other embodiments, the cell assembly 160 may include catalyst material 92 that is positioned between the diamond particles 90 and the substrate 110 or between the diamond particles 90 and the additional catalyst material (not shown).

The cell assembly 160, which includes the diamond particles 90 and the substrate 110 is introduced to a press that is capable of and adapted to introduce ultra-high pressures and elevated temperatures to the cell assembly 160 in an HPHT process, as shown in step 408. The press type may be a belt press, a cubic press, or other suitable presses. The pressures and temperatures of the HPHT process that are introduced to the cell assembly 160 are transferred to contents of the cell assembly 160. In particular, the HPHT process introduces pressure and temperature conditions to the diamond particles 90 at which diamond is stable and inter-diamond bonds form. The temperature of the HPHT process may be at least about 1000° C. (e.g., about 1200° C. to about 1800° C., or about 1300° C. to about 1600° C.) and the pressure of the HPHT process may be at least 4.0 GPa (e.g., about 4.0 GPa to about 12.0 GPa, or about 5.0 GPa to about 10 GPa, or about 5.0 GPa to about 8.0 GPa) for a time sufficient for adjacent diamond particles 90 to bond to one another, thereby forming an integral PCD compact having the polycrystalline diamond body 120 and the substrate 110 that are bonded to one another.

The polycrystalline diamond body 120 may undergo an intermediate manufacturing step 410 to recover the polycrystalline diamond compact 90 and to modify the shape of the polycrystalline diamond compact 90 for subsequent manufacturing steps. In one embodiment, which is depicted in greater detail in FIG. 5, the polycrystalline diamond body 120 may be machined to have a generally planar top surface 150 (which corresponds to, but contains excess material as compared to the working surface 122 of the finished polycrystalline diamond cutting element 100), a cylindrical surface 152 that is cylindrically symmetrical about the centerline axis 128, and a frustonical side surface 154 that extends between the cylindrical surface 152 and the top surface 150. The frustonical side surface 154 may taper from the cylindrical surface 152 towards the top surface 150, such that the polycrystalline diamond compact 90 has a larger diameter at the cylindrical surface 152 than the diameter at the top surface 150. In one embodiment, the frustoconical side surface 154 tapers at an angle of less than about 15 degrees from parallel with the centerline axis 128 of the polycrystalline diamond compact 90.

Referring again to FIG. 4, the polycrystalline diamond body 120 may undergo a leaching process in which the catalyst material is removed from the polycrystalline diamond body 120, as depicted in step 412. The leaching process may remove catalyst material from the interstitial regions of the polycrystalline diamond body 120 that are accessible to the leaching agent. Suitable leaching agents may be selected based on the solubility of the catalyst material that is present in the polycrystalline diamond body 120. Examples of such leaching agents include, for example and without limitation, ferric chloride, cupric chloride, nitric acid, hydrochloric acid, hydrofluoric acid, aqua region, or solutions or mixtures thereof. The leaching agent may be held in an acid bath that is maintained at an pre-selected temperature to modify the rate of removal of the catalyst material 92 from the polycrystalline diamond body 120, including being in a temperature range from about 10° C. to about the boiling point of the leaching agent. In some embodiments, the acid bath may be maintained at elevated pressures that increase the liquid boiling temperature and thus allow the use of elevated temperatures, for example being at a temperature of greater than the boiling point of the leaching agent. The polycrystalline diamond body 120 may be subjected to the leaching process for a time sufficient to remove the desired quantity of catalyst material 92 from the polycrystalline diamond body. The polycrystalline diamond body 120 may be subjected to the leaching process for a time that ranges from about one hour to about one month, including ranging from about one day to about 7 days.

In some embodiments, the polycrystalline diamond body 120 may be maintained in the leaching process until the polycrystalline diamond body 120 is at least partially leached. In polycrystalline diamond bodies 120 that are partially leached, the exterior regions of the polycrystalline diamond bodies 120 that are positioned along the outer surfaces of the polycrystalline diamond bodies 120 have the accessible interstitial regions depleted of catalyst material 92, forming the catalyst depleted portions, while the interior regions of the polycrystalline diamond bodies 120 are rich with catalyst material 92. In such partially leached polycrystalline diamond bodies 120, all of the accessible interstitial regions between the diamond grains may be fully depleted of catalyst material 92 to a depth. In some embodiments, metal carbide that is introduced to the polycrystalline diamond body 120 during the HPHT process may remain in the accessible interstitial regions.

The leaching process discussed hereinabove introduces the catalyst depleted portion, the catalyst rich portion, and the intersection separating the catalyst depleted portion and the catalyst rich portion to the polycrystalline diamond body 120. This intermediately-manufactured polycrystalline diamond body 120, therefore, exhibits the elements of the catalyst depleted portion, the catalyst rich portion, and the intersection discussed hereinabove in regard to the fully finished polycrystalline diamond cutting element 100.

Following the desired duration of leaching of the polycrystalline diamond body 120, the polycrystalline diamond body 120 continues to exhibit non-diamond components that are present in the trapped interstitial regions of the polycrystalline diamond body 120 that are positioned between bonded diamond grains in at least detectable amounts. However, the reduction of the non-diamond components (including catalyst material 92) in the leaching process accessible interstitial regions reduces the content of catalyst material 92 in the polycrystalline diamond body 120 and increases the thermal stability of the polycrystalline diamond body 120.

The polycrystalline diamond compact 90 may subsequently be processed through a variety of finishing operations to remove excess material from the polycrystalline diamond compact 90, as shown in step 418. The polycrystalline diamond compact 90 may be machined to remove material along the top surface 150, thereby forming the working surface 122, and remove material along the cylindrical surface 152 and the frustoconical surface 154, thereby forming the peripheral surface 124. Such finishing operations may include, for example, grinding and polishing the outside diameter of the PCD compact 82, cutting, grinding, lapping, and polishing the opposing faces (both the support-substrate-side face and the diamond-body-side face) of the polycrystalline diamond compact 90, and grinding and lapping a chamfer into the polycrystalline diamond compact 90 between the working surface 122 and the peripheral surface 124.

It should now be understood that polycrystalline diamond cutting elements according to the present disclosure may include a modified catalyst depleted portion. The modified catalyst depleted portion may fabricated by leaching a polycrystalline diamond compact having a frustoconical side surface that tapers from a cylindrical surface towards a top surface of the polycrystalline diamond compact, such that the polycrystalline diamond compact has a larger diameter at the cylindrical surface than the diameter at the top surface. When the polycrystalline diamond compact is subjected to a leaching operation, the frustoconical surface allows a leaching agent to be advantageously positioned to remove catalyst material from interstitial regions of the polycrystalline diamond compact that are positioned proximate to material to be removed in an end-user application.

1. A polycrystalline diamond cutting element comprising:
a substrate; and
a polycrystalline diamond body attached to the substrate along an interface, the polycrystalline diamond body comprising a plurality of inter-bonded diamond grains separated from one another by interstitial regions,
wherein the polycrystalline diamond body comprises a generally planar working surface and a peripheral surface that extends transverse to the working surface,
wherein the polycrystalline diamond body comprises a catalyst rich portion in which the interstitial regions of the polycrystalline diamond body comprise catalyst material, and a catalyst depleted portion in which the interstitial regions of the polycrystalline diamond body are substantially free of catalyst material, wherein an intersection of the catalyst rich portion and the catalyst depleted portion of the polycrystalline diamond body create a catalyst transition zone,
wherein the catalyst transition zone comprises a generally planar portion that is surrounded by an arcuate portion, and
wherein a center of a radius of curvature of the arcuate portion is spaced closer to the working surface than to the peripheral surface of the polycrystalline diamond body.

2. The polycrystalline diamond cutting element of claim 1, wherein a line extending from an intersection between the working surface and the peripheral cylindrical surface of the polycrystalline diamond body and a center of a radius of curvature of the arcuate portion forms an angle with the working surface of the polycrystalline diamond body that is less than about 40 degrees.

3. The polycrystalline diamond cutting element of claim 1, wherein the catalyst transition zone further comprises a frustoconical portion that extends from the arcuate portion.

4. The polycrystalline diamond cutting element of claim 1, wherein a tangency point of the catalyst transition zone at the planar portion to the arcuate portion is spaced apart from the peripheral surface a distance that is greater than the radius of curvature of the arcuate portion.

5. A polycrystalline diamond compact comprising:
a substrate; and
an axially symmetric polycrystalline diamond body attached to the substrate along an interface, the polycrystalline diamond body comprising a generally planar working surface and a frustoconical side surface that extends away from the working surface and intersects with a generally cylindrical surface and that extends along at least 50% of a thickness of the polycrystalline diamond body such that the polycrystalline diamond body has a smaller diameter at the working surface than at the interface.

6. The polycrystalline diamond compact of claim 5, wherein the frustoconical side surface tapers at an angle of less than about 15 degrees from parallel with an axis of symmetry of the polycrystalline diamond body.

7. The polycrystalline diamond compact of claim 5, wherein the polycrystalline diamond body comprises a plurality of inter-bonded diamond grains separated from one another by interstitial regions, and at least a portion of the interstitial regions comprise catalyst material.

8. The polycrystalline diamond compact of claim 7, wherein the polycrystalline diamond body comprises a catalyst rich portion in which the interstitial regions of the polycrystalline diamond body comprise catalyst material, and a catalyst depleted portion in which the interstitial regions of the polycrystalline diamond body are substantially free of catalyst material.

9. The polycrystalline diamond compact of claim 8, wherein:
an intersection of the catalyst rich portion and the catalyst depleted portion of the polycrystalline diamond body create a catalyst transition zone,
the catalyst transition zone comprises a generally planar portion that is surrounded by an arcuate portion, and
a center of a radius of curvature of the arcuate portion is spaced closer to the working surface than to the frustoconical side surface of the polycrystalline diamond body.

10. The polycrystalline diamond compact of claim 9, wherein a line extending from an intersection between the working surface and the peripheral cylindrical surface of the polycrystalline diamond body and a center of a radius of curvature of the arcuate portion forms an angle with the working surface of the polycrystalline diamond body that is less than about 40 degrees.

11. The polycrystalline diamond cutting element of claim 9, wherein the catalyst transition zone further comprises a frustoconical portion that extends from the arcuate portion.

12. The polycrystalline diamond cutting element of claim 9, wherein a tangency point of the catalyst transition zone at the planar portion to the arcuate portion is spaced apart from the frustoconical side surface a distance that is greater than the radius of curvature of the arcuate portion.

13. A method of making a polycrystalline diamond cutting element comprising:
removing inter-bonded diamond grains along an outer surface of a polycrystalline diamond compact to form a frustoconical surface that extends away from a generally planar working surface and intersects with a generally cylindrical surface such that the polycrystalline diamond body has a smaller diameter at the working surface than at the interface;
introducing the polycrystalline diamond compact to a leaching process in which catalyst material that is positioned within interstitial regions between the inter-bonded diamond grains is removed from the polycrystalline diamond compact, wherein the working surface and the frustoconical surface are maintained in intimate contact with a leaching agent;
removing inter-bonded diamond grains along the outer surface of the polycrystalline diamond compact to form a polycrystalline diamond cutting element having a peripheral surface.

14. The method of claim 13, wherein the polycrystalline diamond compact is generally axially symmetric.

15. The method of claim 13, wherein, subsequent to the leaching process, the polycrystalline diamond body comprises a catalyst rich portion in which the interstitial regions of the polycrystalline diamond body comprise catalyst material, and a catalyst depleted portion in which the interstitial regions of the polycrystalline diamond body are substantially free of catalyst material.

16. The method of claim 15, wherein:
an intersection of the catalyst rich portion and the catalyst depleted portion of the polycrystalline diamond body create a catalyst transition zone,
the catalyst transition zone comprises a generally planar portion that is surrounded by an arcuate portion, and
a center of a radius of curvature of the arcuate portion is spaced closer to the working surface than to the frustoconical side surface of the polycrystalline diamond body.

17. The method of claim 16, wherein the catalyst transition zone further comprises a frustoconical portion that extends from the arcuate portion.

18. The method of claim 16, wherein a tangency point of the catalyst transition zone at the planar portion to the arcuate portion is spaced apart from the frustoconical side surface a distance that is greater than the radius of curvature of the arcuate portion.

19. The method of claim 15, wherein:
an intersection of the catalyst rich portion and the catalyst depleted portion of the polycrystalline diamond body create a catalyst transition zone,
the catalyst transition zone comprises a generally planar portion that is surrounded by an arcuate portion, and
a center of a radius of curvature of the arcuate portion is spaced closer to the working surface than to the cylindrial side surface of the polycrystalline diamond cutting element.

20. The method of claim 19, wherein a tangency point of the catalyst transition zone at the planar portion to the arcuate portion is spaced apart from the peripheral surface a distance that is greater than the radius of curvature of the arcuate portion.

21. The method of claim 13, further comprising positioning a leaching agent barrier to contact the polycrystalline diamond body along the frustoconical side surface.

22. The method of claim 21, wherein the leaching process contacts the generally planar surface and a portion of the frustoconical side surface with the leaching agent.
